(19) United States
(12) Patent Application Publication
(10) Pub. No.: US 2025/0211991 A1
(43) Pub. Date: Jun. 26, 2025

(54) REMEDIATION METHODS FOR ROGUE BKDS

(71) Applicant: Cisco Technology, Inc., San Jose, CA (US)

(72) Inventors: Jerome HENRY, Pittsboro, NC (US); Sivadeep R. KALAVAKURU, Pleasanton, CA (US); Ugo M. CAMPIGLIO, Morges (CH); Ardalan ALIZADEH, Campbell, CA (US); Amine CHOUKIR, Ecublens (CH); Matthew A. SILVERMAN, Shaker Heights, OH (US); Peiman AMINI, Fremont, CA (US); Indermeet S. GANDHI, San Jose, CA (US); Robert E. BARTON, Richmond (CA); Domenico FICARA, Essertines-Sur-Yverdon (CH); Juan Carlos ZUNIGA, Montreal (CA); Sachin D. WAKUDKAR, St-Sulpice (CH); Mathieu B. MONNEY, Bussigny (CH)

(21) Appl. No.: 18/597,572

(22) Filed: Mar. 6, 2024

Related U.S. Application Data
(60) Provisional application No. 63/613,702, filed on Dec. 21, 2023.

(51) Int. Cl. H04W 12/122; H04W 84/12

(52) U.S. Cl. CPC H04W 12/122; H04W 84/12

(57) ABSTRACT

Embodiments herein describe mitigating the impacts of rogue AMP STAs on wireless networks (e.g., a Wi-Fi network). Rogue AMP STAs can be placed innocently or by a nefarious actor in coverage area of the wireless network. The rogue AMP STA can create interference between non-rogue AMP STAs and access points (AP), as well as create security risks. The embodiments herein can performed by a transmitting AP or a receiving AP to prevent a rogue AMP STA from transmitting or mitigate the impact the rogue AMP STA has when transmitting.

### CROSS-REFERENCE TO RELATED APPLICATIONS

This application claims benefit of co-pending U.S. provisional patent application Ser. No. 63/613,702 filed Dec. 21, 2023. The aforementioned related patent application is herein incorporated by reference in its entirety.

### TECHNICAL FIELD

Embodiments presented in this disclosure generally relate to mitigating the impact of rogue passive and active backscattering devices on Wi-Fi networks.

### BACKGROUND

In the IEEE 802.11 working group, the AMP (AMbient Power) study group is considering the integration of AMP STAs into Wi-Fi networks. Generally, a system transmits energy that AMP STAs receive and use for their own transmissions. In one form, the AMP STA is entirely passive, and merely reflects (thus in real time) the energy (referred to as backscattering). In another form, the AMP STA can accumulate the energy in an energy storage component, such as a capacitor, until reaching a threshold at which transmission becomes possible (thus transmission is not concurrent to the received Wi-Fi signal, but can still happen at any time after enough energy has accumulated).

The proliferation of low-cost AMP STAs has increased the risk of unauthorized and potentially malicious AMP STAs being illegally deployed in wireless networks to cause interference and service degradation, this can include active AMP STAs (a-AMP STAs or active backscattering devices (a-BKDs)) that store energy and passive AMP STAs (p-AMP STAs or passive BKDs (p-BKDs)) that modulate and reflect received energy. Note that the discussion below uses AMP STA as an equivalent to BKD, and specifies a-AMP STA/p-AMP STA when useful.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a wireless network with rogue and non-rogue AMP STAs, according to one embodiment.

FIG. 2 is flowchart for performing receive nulling to mitigate the impact of a rogue AMP STA, according to one embodiment.

FIG. 3 is flowchart for performing transmit nulling to mitigate the impact of a rogue AMP STA, according to one embodiment.

FIG. 4 is flowchart for limiting the reflection of a rogue AMP STA, according to one embodiment.

FIG. 5 is flowchart for draining the stored energy in a rogue AMP STA, according to one embodiment.

FIG. 6 is flowchart for identifying rogue energizers that power rogue AMP STAs, according to one embodiment.

FIG. 7 illustrates a wireless network with AMP STAs assigned different codes for transmission, according to one embodiment.

FIG. 8 is flowchart for assigning orthogonal codes to different AMP STAs, according to one embodiment.

FIG. 9 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a network device that includes one or more processors and memory storing an application that, when executed by the one or more processors, performs an operation. The operation includes identifying a wireless transmission from a rogue ambient power station (AMP STA) and configuring at least two radio chains to receive wireless transmissions from the rogue AMP STA and phase align the wireless transmission such that the wireless transmission received on the two radio chains cancel each other out.

Another embodiment in this disclosure is a network device that includes one or more processors and memory storing an application that, when executed by the one or more processors, performs an operation. The operation includes identifying a rogue AMP STA, instructing a non-rogue AMP STA to switch into a sleep mode, and transmitting, while the non-rogue AMP STA is in the sleep mode, a sounding frame to the rogue AMP STA. Further, a Wi-Fi device is configured to receive a reflected signal from the rogue AMP STA based on the sounding frame and select one of a plurality of receiver channels on the Wi-Fi device as a nulling path for receiving future wireless transmission from the rogue AMP STA.

Another embodiment in this disclosure is a network device that includes one or more processors and memory storing an application that, when executed by the one or more processors, performs an operation. The operation includes identifying passive AMP STAs that transmit simultaneously when energized and assigning orthogonal codes to the AMP STAs to be used when modulating reflected wireless signals.

### EXAMPLE EMBODIMENTS

Embodiments herein describe mitigating the impact of rogue AMP STAs on wireless networks (e.g., a Wi-Fi network). Rogue AMP STAs can be placed innocently or by a nefarious actor in a coverage area of a wireless network. The rogue AMP STA can create interference between non-rogue AMP STAs and access points (AP), as well as create security risks.

In one embodiment, an AP can perform receive (RX) nulling to mitigate the effects of a rogue AMP STA. For example, a RX AP can receive the signal from the rogue AMP STA on two radio chains. The signals can be aligned so that the signals cancel each other out.

In another embodiment, an AP can perform transmit (TX) nulling to mitigate the effects of a rogue AMP STA. A TX AP can sound the wireless channel when the non-rogue AMP STAs are silent (e.g., are asleep) while a RX AP measures the signal received from the rogue AMP STA. Multiple combinations of TX APs and RX APs can be used to sound the channel. Using the information gained from sounding the channel, the TX AP can use beamforming so that the reflected signal from the rogue AMP STA is received at particular RX channel on the RX AP while the reflected signals from the non-rogue AMP STAs are received on other RX channels on the RX AP. The RX AP can simply ignore the RX channel that receives the signal from the rogue AMP STA.

In yet other embodiments, orthogonal codes can be used to mitigate collisions between AMP STAs and to identify and ignore rogue AMP STAs. For example, multiple non-rogue AMP STAs may transmit at the same time, which can make it difficult for the RX AP to decode their respective signals. Instead, the AMP STAs can be assigned orthogonal codes to make it easier for the RX AP to identify their signals. Further, if a rogue AMP STA is identified, it can be assigned an orthogonal code relative to the non-rogue AMP STAs, which can make it easier for the RX AP to separate the signals received from the non-rogue AMP STAs from the signal received from the rogue AMP STA.

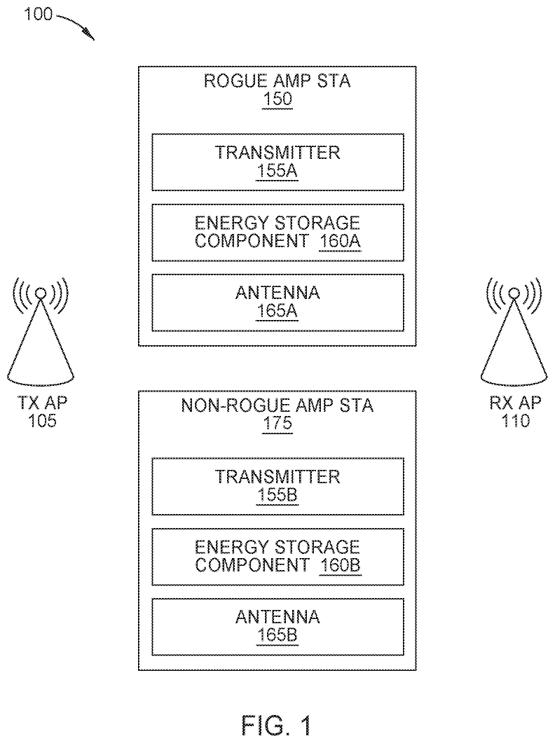

FIG. 1 illustrates a wireless network 100 with rogue and non-rogue AMP STAs, according to one embodiment. In this example, the wireless network 100 is a Wi-Fi network that includes a TX AP 105 which transmits wireless signals to at least one rogue AMP STA 150 and at least one non-rogue AMP STA 175. These AMP STAs 150 and 175 can use the received wireless signal to transmit a wireless signal that is then received by a RX AP 110.

Each AMP STA 150, 175 includes a transmitter 155, an energy storage component 160, and an antenna 165. The transmitter 155 transmits Wi-Fi signals to the AP 110. The energy storage component 160 can be a capacitor for storing power from wireless RF signals received using the antenna 165 on the AMP STA. Thus, the AMP STAs 150 and 175 are active AMP STAs (a-AMP STAs) that can store received wireless power. However, in another embodiment, the AMP STAs 150 and 175 may be passive AMP STAs (p-AMP STAs) in which case it would not have the energy storage component 160.

In one embodiment, the AMP STAs 150 and 175 store power in their respective energy storage component 160. Once a threshold is reached, the transmitter 155 transmits a Wi-Fi signal using the antenna 165. The Wi-Fi signal can include data packets, frames, and the like. In one example, the AMP STA 150 includes other components such as sensors that gather information about the environment, such as an IoT sensor. The data captured by the sensor can be transmitted to the AP 105 using the Wi-Fi signal.

If the AMP STAs 150 and 175 are passive, the transmitter 155 can use a modulation scheme (e.g., on/off keying) to reflect a wireless signal received from the TX AP 105 that is received by the RX AP 110. In one embodiment, the transmitter 155 modulates the signal received from the TX AP 105 which is then reflected to the RX AP 110. For example, the transmitter 155 can change an impedance to create on and off states for on/off keying using the energy in the received wireless signal.

In this example, the rogue AMP 150 is not an approved AMP STA. For example, the AMP STA 150 could have been brought in to a location innocently, or by a nefarious actor. Whether the AMP STA 150 was put in the coverage area of the wireless network 100 innocently or maliciously, the AMP STA 150 can create interference between the non-rogue AMP STA 175 and the RX AP 110, which can make it more difficult (or impossible) for the RX AP 110 to decode the wireless transmissions from the non-rogue AMP STA 175.

In some embodiments, the RX AP 110 performs RX nulling to mitigate the effects of the rogue AMP STA 150 when transmitting in parallel with the non-rogue AMP STA 175. In other embodiments, the TX AP 105 performs TX nulling to mitigate the effects of the rogue AMP STA 150 when transmitting in parallel with the non-rogue AMP STA 175. These are discussed in more detail below.

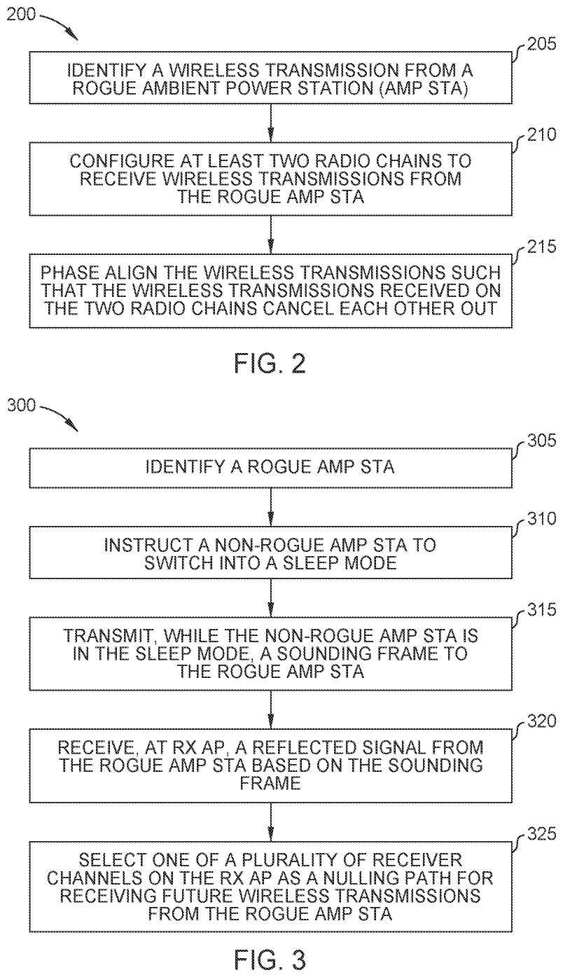

FIG. 2 is flowchart of a method 200 for performing RX nulling to mitigate the impact of a rogue AMP STA, according to one embodiment. At block 205, the wireless network (e.g., an AP such as a TX AP or a RX AP) identifies a wireless transmission from a rogue AMP STA. In one embodiment, a rogue AMP STA can be identified using identifiers (IDs). When transmitting, the AMP STAs may include its ID. In one example, the APs in the wireless network may know the IDs of the AMP STAs that have been approved for use in the wireless network (i.e., a list of IDs for non-rogue AMP STAs). If an AP receives an ID from an AMP STA that is not on the list, the AP can mark the AMP STA as a rogue AMP STA.

At block 210, the RX AP configures at least two radio chains to receive wireless transmissions from the rogue AMP STA. Specifically, the RX AP can configure the radio chains so they will cancel out the signals received from the rogue AMP STA while the wireless transmissions received from non-rogue AMP STAs on the radio chains are not cancelled out.

In one embodiment, the RX AP determines a spatial signature of the rogue AMP STA, which can include a multiple path channel between the RX AP and the combination of the rogue devices and whatever other devices are excited along with the rogue AMP STA. Using the spatial signature, the RX AP can configure the radio chains to null the signals received from the rogue AMP STA.

At block 215, the radio chains phase aligns the wireless transmissions received from the rogue AMP STA so they cancel each other out. For example, in response to detecting the ID of the rogue AMP STA, the RX AP aligns the signals received on the RX chains with a 180 degree shift, thus nulling the message from the rogue AMP STA. This nulling can occur in the radio frequency (RF) domain with analog signals or in the digital domain using baseband signal processing. So long as other transmissions in the basic service set (BSS) (e.g., transmissions from non-rogue AMP STA) are not phase aligned with the transmission from the rogue AMP STA, the RX AP can still decode the frames received at the same time from other sources.

RX nulling as described in method 200 can be performed with both passive and active AMP STAs. For passive rogue AMP STAs, the method 200 can be timed to be performed when the TX AP transmits energizing signals. For active rogue AMP STAS, they can store energy and transmit according to different criteria. As such, the RX AP can determine the periodicity or interval at which the active AMP STA transmits and then perform method 200. In another embodiment, the RX AP can store the configuration in the RX path so any received signals from the active AMP STA will be nulled, regardless when the active AMP STA transmits.

FIG. 3 is flowchart of a method 300 for performing TX nulling to mitigate the impact of a rogue AMP STA, according to one embodiment. At block 305, an AP identifies a rogue AMP STA that transmits wireless data in the network. In one embodiment, a rogue AMP STA can be identified using an ID that is included in the wireless transmissions the AMP STA sends. In one example, the APs in the wireless network may know the IDs of the AMP STAs that have been approved for use in the wireless network (i.e., non-rogue AMP STAs). If an AP receives an ID from an AMP STA that is not on the list, the AP can mark the AMP STA as a rogue AMP STA.

At block 310, a TX AP instructs the non-rogue AMP STAs to switch into a sleep mode. Doing so prevents the non-rogue AMP STAs from transmitting during the next blocks of the method 300. The TX AP can use the IDs of the non-rogue AMP STAs to select which of the non-rogue AMP STAs (e.g., all of them) are switched into the sleep mode so that they do not reflect received signals. If all of the non-rogue AMP STAs are put to sleep, then only the rogue AMP STA will transmit a signal when energized by the TX AP.

At block 315, the TX AP transmits, while the non-rogue AMP STA(s) are in the sleep mode, a sounding frame to the rogue AMP STA. In one embodiment, the sounding is performed multiple times using different combinations of TX APs and RX APs in the network. For example, sounding may be performed using AP 1 as the TX AP and AP 2 as the RX AP, and then using AP 3 as the TX AP and AP 2 as the RX AP, and then using AP 1 as the TX AP and AP 4 as the RX AP, and then using AP 3 as the TX AP and AP 4 as the RX AP, and so forth.

The sounding frames can include a postfix appended to them that act as an excitation frame, which excites the rogue AMP STA so it modulates, and reflects, the received energy from the TX AP(s).

At block 320, the RX AP(s) receives a reflected signal from the rogue AMP STA based on the sounding frame(s). The RX AP(s) can process the reflected signal to determine a channel estimate of the path between the RX AP(s) and the rogue AMP STA.

In one embodiment, the RX AP(s) generates a compressed steering for both states of the rogue AMP STA (e.g., the “on” and “off” antennas states of the rogue AMP STA). That is, the RX AP can estimate the channel for both the on and off states of the rogue AMP STA.

At block 325, the RX AP(s) selects one of a plurality of receiver channels on the RX AP as a nulling path for receiving future wireless transmission from the rogue AMP STA. Put differently, the RX APs select a respective RX path that, when the TX AP transmits a future frame, can null the reflected signals from the rogue AMP STA.

For example, the RX AP may include four RX paths where the channel estimates determined by performing the method 300 can direct the signals transmitted by the rogue AMP STA to one of those four RX paths. The other three RX paths can be used to receive signals transmitted by the non-rogue AMP STAs. The RX AP can ignore the data received on the first RX path but process the data received on the other three RX paths from the non-rogue AMP STAs.

In one embodiment, to direct the energy transmitted by the rogue AMP STA to the selected RX path on the RX AP(s), the TX AP can use beamforming. The beamforming values can be determined using the channel estimates obtained at block 320—e.g., the channel estimates for the on and off antenna states of the rogue AMP STA. The TX AP can then wake up the non-rogue AMP STAs (i.e., switch to an active mode). In this manner, for future excitations, the TX AP nulls the transmissions from the rogue AMP STA to the RX AP because the energy for the rogue AMP STA ends up on the nulled RX path, while the transmissions from the non-rogue AMP STA(s) are received on non-nulled RX path(s) on the RX AP.

In one embodiment, the RX AP(s) feedback the compressed steering from the channel estimates of the two states of the rogue AMP STA to the TX AP, along with the index(es) for the RX path (or paths) that the RX AP has chosen as the nulling path (or paths). However, in another embodiment, the choice of the nulling path(s) used by the RX AP(s) is left to the TX AP, which then notifies the RX AP(s) of the RX paths that should be used so that the RX AP(s) know which RX path(s) to ignore. These notifications from the RX AP(s) to the TX AP(s) and from the TX APs to the RX AP(s) can be performed on a semi-static basis (e.g., every 1 second) or through signaling in a transmit opportunity (TxOp). If the coordination between the RX and TX APs occurs on a semi-static basis, these messages could be a new action frame indicated in a new AMP STA information element (IE). If done using TxOps, this signaling could be in a BKD-specific trigger frame.

In one embodiment, the rogue AMP STA used in the method 300 is a passive AMP STA. While the method 300 may be used with an active AMP STA, active AMP STAs can transmit Wi-Fi frames (e.g., a typical PHY frame), while passive AMP STAs do not have this ability. Instead, passive AMP STAs reflect received signals which are modulated using a simple modulation scheme, such as on/off keying. With active AMP STA, since it transmits an actual PHY frame, the RX AP can determine how to null the packet using RX nulling. As such, performing RX nulling as described in the method 200 may be preferred for active AMP STAs.

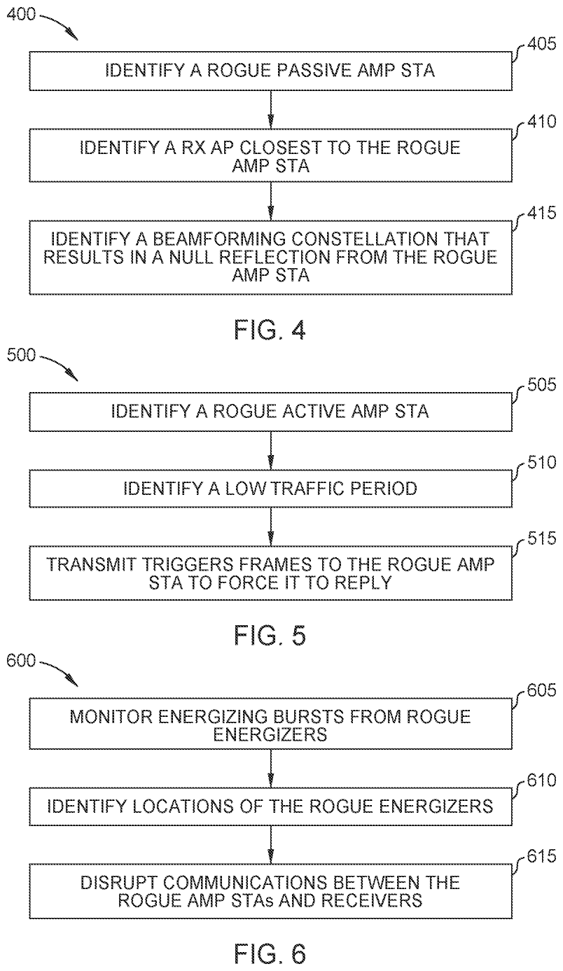

FIG. 4 is flowchart of a method 400 for limiting the reflection of a rogue AMP STA, according to one embodiment. In one embodiment, the method 400 can be used to create a dead zone where a rogue AMP STA is located so that the rogue AMP STA is not able to transmit.

At block 405, an AP (e.g., a TX or a RX AP) identifies a rogue passive AMP STA. As mentioned above, a rogue AMP STA can be identified using an ID that is included in the wireless transmissions the AMP STA sends. In one example, the APs in the wireless network may know the IDs of the AMP STAs that have been approved for use in the wireless network (i.e., non-rogue AMP STAs). If an AP receives an ID from an AMP STA that is not on the list, the AP can mark the AMP STA as a rogue AMP STA.

At block 410, the AP identifies a RX AP closest to the rogue AMP STA. For example, the APs that receive messages from the rogue AMP STA can be polled to determine which one reported the largest signal strength (e.g., a received signal strength indicator (RSSI)). Or the RX APs can provide the RSSI to the TX AP, or a central controller (e.g., a wireless LAN controller (WLC)). The RX AP with the largest RSSI can be identified as the AP that is closest to the rogue AMP STA.

At block 415, an AP (or a central controller) identifies a beamforming constellation that results in a null reflection from the rogue AMP STA. For example, when the TX AP transmits, it can use beamforming so that the TX AP(s) do not receive any reflection from the rogue AMP STA.

In one embodiment, the beamforming constellation can be identified using a feedback loop from the RX AP to the TX AP. When the TX AP is transmitting, the RX AP can report on the signal it received from the rogue AMP STA. The TX AP can change beamforming parameters until the RX AP indicates it did not receive any signal (or a signal below a threshold) from the rogue AMP STA. This can create a RF blind spot at the position of the rogue AMP STA. The TX AP can then use these beamforming parameters as often as possible, thereby limiting the ability of the rogue AMP STA to receive and reflect energy.

FIG. 5 is flowchart of a method 500 for draining the stored energy in a rogue AMP STA, according to one embodiment. In one embodiment, the method 500 can be used to control when a rogue active AMP STA transmits. For example, an active AMP STA often transmits when its energy storage component (e.g., the energy storage component 160 in FIG. 1) reaches a threshold. This fact can be leveraged by the method 500 to force the rogue AMP STA to transmit when its transmission will cause no harm or at least reduce the harmful effects of its transmission. For example, the method 500 can force the rogue AMP STA to transmit when there is not much traffic being transmitted in the Wi-Fi network (e.g., at night).

At block 505, an AP identifies a rogue active AMP STA. Unlike a passive AMP STA, an active AMP STA may not transmit until its energy storage component has reached a threshold. Thus, the APs in the Wi-Fi network may not know when the rogue active AMP STA will transmit.

A rogue active AMP STA can be determined based on an ID in the messages it transmits. In one example, the APs in the wireless network may know the IDs of the AMP STAs that have been approved for use in the wireless network (i.e., non-rogue AMP STAs). If an AP receives an ID from an active AMP STA that is not on the list, the AP can mark the AMP STA as a rogue active AMP STA.

At block 510, the AP or central controller (e.g., a WLC) identifies a low traffic period. This could be identified based on a traffic history of the Wi-Fi network. For example, the AP may determine one or more time periods during the day where there is low traffic which could include nighttime hours, Holidays, or for a school, when students are in their classes (in contrast to the time between classes when Wi-Fi traffic may spike). However, the embodiments are not limited to any particular method or technique for identifying low traffic periods.

At block 515, one or more APs transmit trigger frames to the rogue AMP STA to force it to reply. For example, the AP(s) can transmit frames with the intention of charging the energy storage component so that the rogue AMP STA transmits. The AP can use some of the techniques above to force the rogue AMP STA to transmit. This can include using beamforming to focus energy at the rogue AMP STA (in contrast to method 400 which uses beamforming to perform null reflection).

The trigger frames used to drain the rogue active AMP STA are not limited to any particular type of trigger frames. These trigger frames can include identification queries, fictitious null transmission offset frames, and the like. In triggered based transmissions, the TX AP may be able to instruct the rogue AMP STA to use the highest target RSSI when transmitting (i.e., increase the target RSSI used by the AMP STA). This will cause the rogue AMP STA to drain its power quicker.

By draining the energy storage component, the rogue active AMP STA may not be able to transmit for a period of time, such as a high traffic time period. The method 500 may be repeated throughout the day during low traffic time periods to reduce the likelihood the rogue active AMP STA transmits during an undesirable time period (e.g., a high traffic time period).

In addition, the method 500 can be performed along with other methods discussed above. For example, during low traffic time periods, the method 500 can be performed. During high traffic time periods, the method 400 can be performed where beamforming attempts to create a null reflection at the location of the rogue active AMP STA to keep the energy storage component from charging (or at least limit the amount the energy storage component is charged).

In one embodiment, the TX AP transmits beam-formed charging frames until the rogue active AMP STA transmits a frame, as discussed in the method 500. The frame sent by the rogue AMP STA can indicate the energy level of the energy storage component (e.g., capacitor energy level). The TX AP can then modify its beamforming configuration and repeat transmitting the charging frames until the rogue AMP STA transmits. Once the exploration of the beamforming constellation is complete (e.g., the entire beamforming constellation has been explored), the TX AP selects the beamforming configuration that results in the largest interval between transmissions by the rogue AMP STA (i.e., the configuration that minimizes the energy received at the AMP STA). These beamforming configurations can then be used to perform method 400 during high traffic periods to reduce the amount the rogue AMP STA is charged.

Moreover, since the rogue AMP STAs can recharge and gather energy from other powered devices connected to the same network on the same channel, in order to reduce and deplete battery of the rogue AMP STA, the AP can coordinate with the other connected powered clients in the same Wi-Fi network to, one, stop transmitting during a period of time, or two, doing a channel/frequency change. This is a further strategy to attempt to reduce energy harvesting by the rogue AMP STA.

FIG. 6 is flowchart of a method 600 for identifying rogue energizers that power rogue AMP STAs, according to one embodiment. A rogue energizer might not be a nefarious actor, but may nonetheless unwittingly provide energy to a rogue AMP STA. A rogue energizer can be any Wi-Fi device that does not listen to an AP or a controller when it instructs the rogue energizer to perform a strategy to reduce the negative impact of rogue AMP STA.

Notably, AMP STAs are useless on their own. When rogue AMP STAs are placed in a location of the Wi-Fi network (either maliciously or innocently), the rogue AMP STAs has to be energized to work. The method 600 focuses on the rogue energizer in the case it coincides with the rogue AMP STA such that the rogue energizer powers the rogue AMP STA (which can be a passive or an active AMP STA).

At block 605, managed APs monitor energizing bursts from rogue energizers. In one embodiment, the APs determine a pattern of the energizing bursts from the rouge energizer and the reply from the rogue AMP STA. In addition, the APs can report the patterns, measured signal, and spectrum to a controller (e.g., WLC or controller in the AP).

At block 610, the controller identifies a location of the rogue energizer. For example, the controller can determine the probable location and the details of the rogue energizer and the rogue AMP STA using the pattern, measured signal, and spectrum received from the AP.

At block 615, the AP (or APs) proximate to the location of the rogue energizer disrupt communications between the rogue AMP STAs and a receiver (which may be a rogue Wi-Fi device). In one embodiment, the AP introduces noise according to the pattern of when the rogue AMP STA transmits to the receiver using the power provided by the rogue energizer. That is, the AP can transmit simultaneously when the rogue AMP STA transmits to the receiver to disrupt communications.

In one embodiment, the rogue energizer can be a powered client that is secretly powering another rogue AMP STA and not fulfilling ‘stop transmission request’ of the AP. The powered device can be identified as a rogue energizer by an AP by monitoring TX behavior of the connected clients and identifying deviating behaviors. Those clients can then be forcefully disconnected and marked as rogue clients. For example, rogue containment can be used to de-authenticate rogue clients to disconnect them. This causes the rogue client to transmit less (e.g., only send probes once in a while instead of active data transmission).

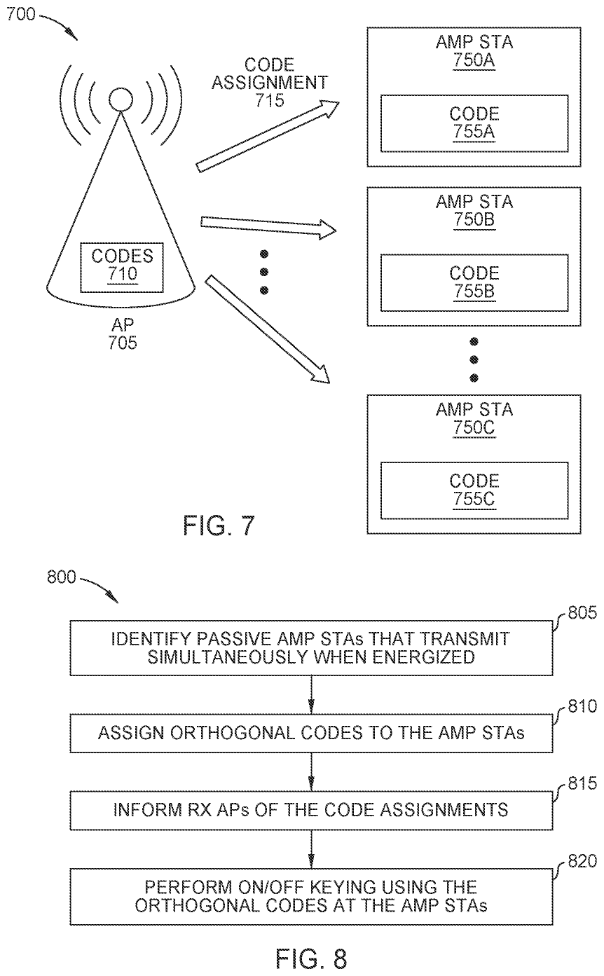

FIG. 7 illustrates a wireless network 700 with AMP STAs 750 assigned different codes 710 for transmission, according to one embodiment. FIG. 7 illustrates an AP 705 that assigns codes 710 to the AMP STAs 750. That is, each AMP STA 750 can be assigned a different code 755. The codes 710 in the AP 705 can be a database of the codes 710 the AP 705 has assigned to AMP STAs 750.

In one embodiment, AMP STAs that should be ignored can be assigned 715 codes 755 that are orthogonal to the codes assigned to other AMP STAs. For example, the AP 705 can identify a rogue AMP STA as discussed above and assign 715 a code 755 to the rogue AMP STA that is orthogonal to the other non-rogue AMP STAs. Thus, when the AMP STAs transmit in parallel (e.g., are passive AMP STAs), the RX AP can use the orthogonal codes to ignore the rogue AMP STA. For example, the rogue AMP STAs may be placed in a blocked list and are assigned codes that are orthogonal to the non-rogue AMP STAs.

While the embodiments discuss assigning orthogonal codes to ignore rogue AMP STAs, the orthogonal codes can be used when any two AMP STAs transmit simultaneously to aid the receiver to separate out their messages. That is, the orthogonal codes can be used by the RX AP to decode the data received from the two non-rogue AMP STAS.

FIG. 8 is flowchart of a method 800 for assigning orthogonal codes to different AMP STAs, according to one embodiment. At block 805, the AP identifies passive AMP STAs that transmit simultaneously when energized. The AP might want to receive data from both the AMP STAs, or the AP may want to be able to distinguish between the AMP STA and a rogue AMP STA so the data received from the rogue AMP STA can be ignored. Further, while method 800 describes two AMP STA, the method 800 can be used for any number of AMP STAs.

At block 810, the AP assigns orthogonal codes to the two AMP STAs. In one embodiment, the AMP STAs are passive AMP STAs that encode their on/off keying onto orthogonal codes that are assigned by the APs. In one embodiment, the receivers (e.g., RX APs) can do a cross correlation against known orthogonal codes in order to isolate a particular device when receiving their on/off keying. In another embodiment, the receiver can include a rake receiver.

An example orthogonal code assignment between two AMP STAs is now described. A first AMP STA 1 can be assigned the codes for on/off keying as follows:
On_AMP_STA_1: [0 1 0 1]
Off_AMP_STA_1: [1 1 0 0]

A second AMP STA 1 can be assigned the codes for on/off keying as follows:
On_AMP_STA_2: [1 0 0 1]
Off_AMP_STA_2: [1 1 1 1]

These on and off codes are orthogonal. That is, the dot product of any of these codes with each other (treating 1 like 1 and 0 like a −1), results in a 0.

At block 815, the AP that assigns the orthogonal codes informs the RX APs of the code assignment. This could be an over-the-air transmission or could be performed using a back channel communication such as using a WLC. For example, the codes can be shared using management frames. If there is already a significant amount of management traffic in the network, the assigned codes can be shared during an AP TxOp.

At block 820, the AMP STAs perform on/off keying using the orthogonal codes. At the receiver, for rogue AMP STAs, correlation of rogues that have codes orthogonal to the AP lead to a zero, thereby suppressing rogue AMP STAs.

Notably, the AMP STAs do not have to be assigned only orthogonal codes. Instead, an AP (or controller) can pick and choose codes for specific AMP STAs that have unusual activity (RF energy level, bandwidth, on/off time etc.) to issue orthogonal codes. Being selective about assigning orthogonal code helps to keep codes short, and also lessens the burden on the TX and RX APs to track the assigned codes.

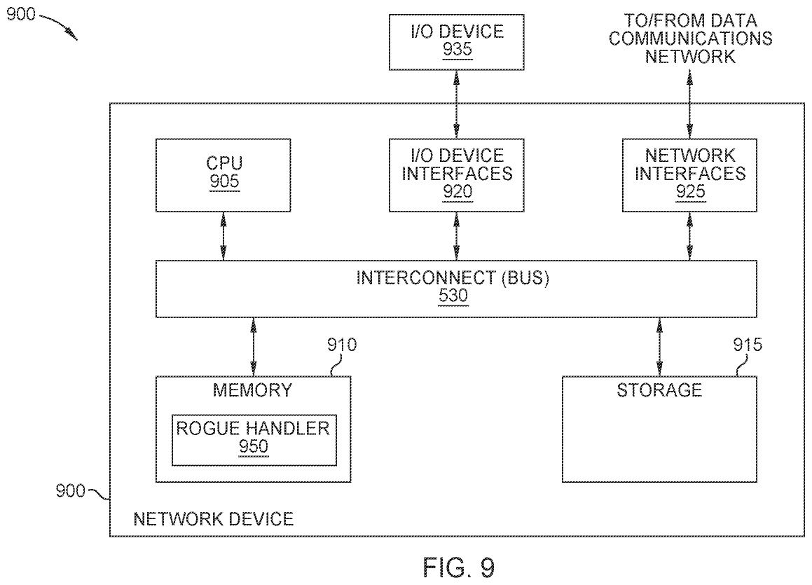

FIG. 9 depicts an example computing device (e.g., a network device 900) configured to perform various aspects of the present disclosure, according to some embodiments of the present disclosure. In some embodiments, the network device 900 corresponds to an AP (e.g., a TX or RX AP) or a WLC. Although depicted as a physical device, in embodiments, the network device 900 may be implemented using virtual device(s), and/or across a number of devices (e.g., in a cloud environment).

As illustrated, the network device 900 includes a CPU 905, memory 910, storage 915, a network interface 925, and one or more I/O interfaces 920. In the illustrated embodiment, the CPU 905 (e.g., one or more processors) retrieves and executes programming instructions stored in memory 910, as well as stores and retrieves application data residing in storage 915. The CPU 905 is generally representative of a single CPU and/or GPU, multiple CPUs and/or GPUs, a single CPU and/or GPU having multiple processing cores, and the like. The memory 910 is generally included to be representative of a random access memory. Storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 935 (such as keyboards, monitors, etc.) are connected via the I/O interface(s) 920. Further, via the network interface 925, the network device 900 can be communicatively coupled with one or more other devices and components (e.g., via a network, which may include the Internet, local network(s), and the like). As illustrated, the CPU 905, memory 910, storage 915, network interface(s) 925, and I/O interface(s) 920 are communicatively coupled by one or more buses 930.

In the illustrated embodiment, the memory 910 includes a rogue handler 950, which may perform one or more embodiments discussed above in FIGS. 2-6 and 8. Although depicted as discrete components for conceptual clarity, in embodiments, the operations of the depicted components (and others not illustrated) may be combined or distributed across any number of components. Further, although depicted as software residing in memory 910, in embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a non-transitory computer readable storage medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A network device, comprising:
one or more processors; and
memory storing an application that, when executed by the one or more processors, performs an operation, the operation comprising:
identifying a wireless transmission from a rogue ambient power station (AMP STA), and
configuring at least two radio chains to receive wireless transmissions from the rogue AMP STA and phase align the wireless transmission such that the wireless transmission received on the two radio chains cancel each other out.

2. The network device of claim 1, wherein the rogue AMP STA comprises a passive backscattering device that does not include an energy storage element.

3. The network device of claim 1, wherein the rogue AMP STA comprises an active backscattering device that includes an energy storage element for storing power from received wireless signals.

4. The network device of claim 1, wherein the two radio chains applies a 180-degree phase shift between wireless transmissions received on respective ones of the two radio chains.

5. A network device, comprising:
one or more processors; and
memory storing an application that, when executed by the one or more processors, performs an operation, the operation comprising:
identifying a rogue AMP STA,
instructing a non-rogue AMP STA to switch into a sleep mode, and
transmitting, while the non-rogue AMP STA is in the sleep mode, a sounding frame to the rogue AMP STA,
wherein a Wi-Fi device is configured to receive a reflected signal from the rogue AMP STA based on the sounding frame and select one of a plurality of receiver channels on the Wi-Fi device as a nulling path for receiving future wireless transmission from the rogue AMP STA.

6. The network device of claim 5, wherein the network device is a first access point (AP) and the Wi-Fi device is a second AP, wherein the first AP is configured to transmit the sounding frame while the second AP receives the reflected signal and selects one of the plurality of receiver channels as the nulling path.

7. The network device of claim 5, wherein the operation further comprises:
providing channel estimates for both on and off states of the rogue AMP STA based on the reflected signal;
generating a compressed steering based on the channel estimates;
instructing the non-rogue AMP STA to switch into an active mode; and
transmitting wireless signals to both the rogue and the non-rogue AMP STAs using the compressed steering so that reflected signals from the rogue AMP STA are received at the selected receiver channel on the Wi-Fi device and are ignored, while reflected signals from the non-rogue AMP STA are received at a different one of the plurality of received channels on the Wi-Fi device.

8. The network device of claim 5, wherein the rogue AMP STA comprises a passive backscattering device that does not include an energy storage element.

9. The network device of claim 5, wherein the operation further comprises:
identifying a beamforming constellation that results in null reflection from the rogue AMP STA to the Wi-Fi device.

10. The network device of claim 5, wherein the operation further comprises:
identifying a low traffic period in a Wi-Fi network; and
transmitting trigger frames to the rogue AMP STA to force the rogue AMP STA to reply, wherein the rogue AMP STA is an active AMP STA.

11. The network device of claim 10, wherein the operation further comprises:
increasing, during the low traffic period, a target RSSI of the rogue AMP STA so the rogue AMP STA uses more power to transmit the reply.

12. The network device of claim 5, wherein the operation further comprises:
monitoring energizing bursts from a rogue energizer that energizes a second rogue AMP STA,
identifying a location of the rogue energizer, and
disrupting communications between the communication between the second rogue AMP STA and a receiver.

13. The network device of claim 12, wherein disrupting the communications comprises the network device transmitting in parallel with the second rogue AMP STA transmitting to the receiver.

14. A network device, comprising:
one or more processors; and
memory storing an application that, when executed by the one or more processors, performs an operation, the operation comprising:
identifying passive AMP STAs that transmit simultaneously when energized; and
assigning orthogonal codes to the AMP STAs to be used when modulating reflected wireless signals.

15. The network device of claim 14, wherein the operation comprises:
informing receive (RX) APs of the code assignments made by the network device.

16. The network device of claim 15, wherein the RX APs receive the reflected signals from the AMP STAs and use the orthogonal codes to distinguish signals received from the AMP STAs.

17. The network device of claim 14, wherein the orthogonal codes are used by the AMP STAs to perform on/off keying.

18. The network device of claim 14, wherein at least one of the AMP STAs is a rogue AMP STA.

19. The network device of claim 18, wherein the operation further comprises:
identifying the rogue AMP STA by receiving a message from the rogue AMP STA that includes an identification (ID) that does not match a list of IDs for non-rogue AMP STAs that are permitted on a Wi-Fi network.

20. The network device of claim 14, wherein the passive AMP STAs are backscattering devices that do not include an energy storage element.
